(19) United States
(12) Patent Application Publication
(10) Pub. No.: US 2007/0101658 A1
(43) Pub. Date: May 10, 2007

(54) Assembly unit including an inside door piece and a carrier element

(75) Inventor: Thomas Heyer, Sassenburg (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/593,840

(22) Filed: Nov. 7, 2006

(30) Foreign Application Priority Data
Nov. 9, 2005 (DE) 20 2005 017 526.9

(51) Int. Cl. B60J 5/04

(52) U.S. Cl. 49/502

(57) ABSTRACT

An assembly unit for a vehicle includes an inside door piece having a mount, and a carrier element having a recess. The recess is surrounded by a protrusion that is able to engage in the mount, which positions the carrier element.

### RELATED APPLICATIONS

The application claims priority to German Patent Application No. 20 2005 017 526.9 which was filed on Nov. 9, 2005.

### BACKGROUND OF THE INVENTION

The invention relates to an assembly unit, particularly for a motor vehicle, that includes an inside door piece and a carrier element.

A carrier element accommodates various components of a window lifter system. In this context, the carrier element may also be part of the window lifter system, e.g. a window lifter rail. For easy installation, the components of the window lifter system are pre-mounted to the carrier element to form an assembly. This assembly will then be delivered as a unit to a vehicle body. The unit can then be attached to an inside door piece. The term “inside door piece” refers to inner structural parts of lateral portions of a vehicle body, especially of a vehicle door.

Up to now, the carrier elements of the unit are fastened to the inside door piece by expensive screwed connections.

It is the object of the invention to further develop an assembly unit that includes an inside door piece and a carrier element to provide a quick and easy installation.

### SUMMARY OF THE INVENTION

To this end, the invention provides an assembly unit that includes an inside door piece and a carrier element. The inside door piece has a mount and the carrier element has a recess that is surrounded by a protrusion. The protrusion is able to engage in the mount, whereby the carrier element is positioned. As soon as the protrusion of the carrier element engages in the mount in the inside door piece, the carrier element is positioned on the inside door piece until it is fastened with a fastening mechanism, for instance. Positioning as well as fastening is easy, because the protrusion only has to be inserted in the mount. The mount in the inside door piece is manufactured during injection-molding or foaming the latter. If the inside door piece is a sheet metal part, the mount can be stamped.

The protrusion is, for instance, a bent edge of the carrier element. The protrusion, which is formed integrally with the carrier element, can reliably take up shear forces after insertion in the mount in the inside door piece.

It is preferred that the protrusion is a plastically deformed portion of the carrier element, e.g. an embossed collar which—as an edge of the recess for a fastening screw—is formed in one piece with the carrier element.

It is preferred that an opening is provided that is centrally arranged in the mount and configured in the nature of a stepped hole. A fastening mechanism is able to be inserted in the opening in order to fasten the carrier element to the inside door piece. The opening directly adjoins the mount; in particular, the mount passes into the opening in the nature of the stepped hole. The fastening mechanism is inserted in the opening through the mount, such as by being screwed in for example. The positioning as well as the fastening is effected by the mount, so that no additional screw mounts or the like are required.

The fastening mechanism may be a self-tapping screw, so that the resultant connection can reliably take up the shear forces when the carrier element has been attached to the inside door piece.

The fastening mechanism may be a screw that is adapted to be threaded into plastic, for instance. Such screws are made of metal and are especially designed for use with plastics. These screws have a high extraction force in plastics.

An insert nut may be provided in the opening. The insert nut is connected with the inside door piece with an interlocking fit, and is highly unsusceptible to rotational movements and withstands high extraction forces.

It will be preferred that a head of the fastening mechanism be chosen such that after inserting the fastening mechanism in the opening, the carrier element is urged against the inside door piece. The carrier element is clamped by the head of the fastening mechanism. The connection is capable of taking up the existent shear forces.

The carrier element can be a door module and the inside door piece can be an inside door steel sheet.

According to the preferred embodiment, the carrier element is a window lifter rail and the inside door piece is a door module. The door module is a foamed or injection-molded plastic piece, for instance, which can be fastened to an inside door steel sheet in the same way.

As an alternative, the carrier element is a window lifter rail and the inside door piece is an inside door steel sheet. In this case, the window lifter rail will be directly fastened to the inside door steel sheet.

Further features and advantages will be apparent from the sub-claims.

These and other features of the present invention can be best understood from the following specification and drawings, the following of which is a brief description.

### BRIEF DESCRIPTION OF THE DRAWINGS

FIG. 1 shows a schematic cross-section through a vehicle door including an assembly unit according to the invention.

FIG. 2 shows an enlarged cut-out of an area designated with X in FIG. 1.

### DETAILED DESCRIPTION OF THE PREFERRED EMBODIMENT

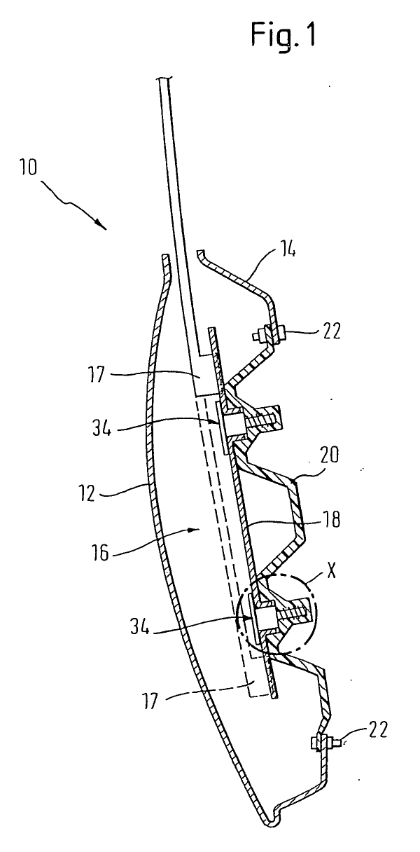

FIG. 1 shows a vehicle door 10, which has, as essential structural components, an outside door steel sheet 12 and an inside door steel sheet 14. Between the outside door steel sheet 12 and the inside door steel sheet 14 there is formed a cavity in which the components of a window lifter system 16 are arranged

The inside door steel sheet 14 is usually made of sheet metal. The term “inside door steel sheet” also includes inner structural parts of a vehicle door when these are not made of metal, but of plastic, for instance.

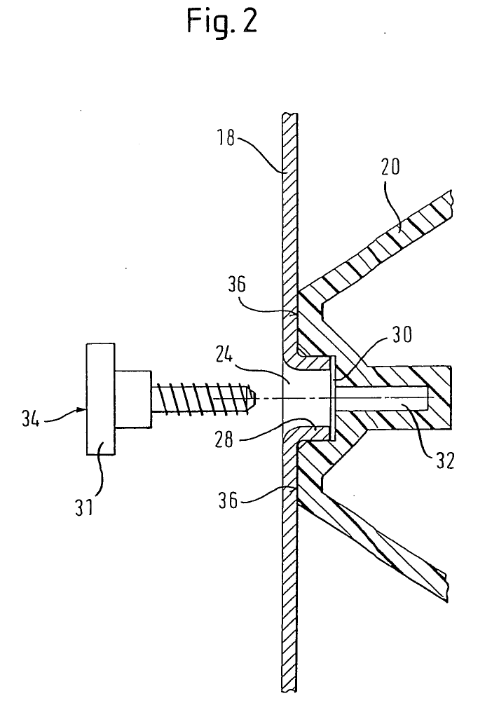

In FIGS. 1 and 2 there is shown an assembly unit including a carrier element 18 and an inside door piece 20. The carrier element 18 is a window lifter rail that is part of the window lifter system 16. A carriage 17 will be displaced on the window lifter rail during opening and closing of a window.

The carrier element 18 is a sheet metal part and has upper and lower recesses 24 (FIG. 2) related to the illustration in FIG. 1. Both recesses 24 are round, have been fabricated during stamping and are surrounded by a bent edge. The bent edge is an embossed collar of the carrier element 18 and forms a cylindrical protrusion 28 that is formed in one piece with the carrier element 18.

The inside door piece 20 is configured as a door module and is made of plastic. The inside door piece 20 is attached on the inside door steel sheet 14 by being screwed, latched or connected with a hook. A screwed connection is schematically shown at 22.

The inside door piece 20 has a mount 30 (FIG. 2) that is produced during injection-molding the inside door piece 20. A depth of the cylindrical mount 30 corresponds to a height of the bent edge, or the mount 30 may be somewhat deeper than the protrusion 28 (as is shown in FIG. 2) in order to completely accommodate the protrusion 28.

Like a stepped hole, the mount 30 passes into an opening 32 or hole arranged in a center of the mount 30. A fastening mechanism 34, which is shown in FIG. 2 as a self-tapping screw, can be screwed in the opening 32 of the inside door piece 20, for fastening the carrier element 18 to the inside door piece 20.

The fastening mechanism 34 has a head 31 with a diameter larger than that of the mount 30 in the inside door piece 20, so that the carrier element 18 is clamped by the head 31 after inserting the fastening mechanism 34.

Positioning and fastening the carrier element 18 on the inside door piece 20 is done as follows: The protrusion 28 of the carrier element 18 is inserted in the cylindrical mount 30 in the inside door piece 20. A diameter of the protrusion 28 and a diameter of the mount 30 are selected here such that the protrusion 28 lies against the edge of the mount 30. As the depth of the mount 30 is larger than the height of the protrusion 28, the carrier element 18 lies against a plane portion 36, surrounding the mount 30, of the inside door piece 20. The carrier element 18 is now positioned on the inside door piece 20.

After positioning, a fitter can screw the fastening mechanism 34 through the mount 30 in the opening 32 in the inside door piece 20. As the fastening mechanism 34 is screwed in, the carrier element 18 is clamped by the head 31 of the fastening mechanism 34, whereby a reliable and easy fastening of the carrier element 18 to the inside door piece 20 is ensured.

In this embodiment, the fastening mechanism 34 is shown as a self-tapping screw. It would likewise be possible to use a special screw of metal that is adapted to be threaded into plastic. This screw could be configured as a self-tapping screw, if appropriate.

An insert nut could be provided in the opening 32; such nut would be connected with the inside door piece 20 with an interlocking fit, whereby resistance to rotational movements would be enhanced.

With the assembly unit which has just been described it is possible to additionally fasten the inside door piece 20 to the inside door steel sheet 14, or in another, likewise not shown embodiment, fasten a window lifter rail directly to the inside door steel sheet 14.

It would also be possible to provide only one upper recess 24 and mount 30; the lower mount 30 could be formed by an elongated hole in the inside door piece 20 and a rivet in the carrier element 18.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An assembly unit comprising:
an inside door piece having a mount; and
a carrier element having a recess that is surrounded by a protrusion, the protrusion being able to engage in the mount to position the carrier element.

2. The assembly unit according to claim 1, wherein the protrusion is a bent edge of the carrier element.

3. The assembly unit according to claim 1, wherein the protrusion is a plastically deformed portion of the carrier element.

4. The assembly unit according to claim 1, including an opening that is centrally arranged in the mount and configured as a stepped hole, and a fastening mechanism to be inserted in the opening to fasten the carrier element to the inside door piece.

5. The assembly unit according to claim 4, wherein the fastening mechanism is a self-tapping screw.

6. The assembly unit according to claim 4, wherein the fastening mechanism is a plastic screw.

7. The assembly unit according to claim 4, including an insert nut in the opening.

8. The assembly unit according to claim 4, wherein a head of the fastening mechanism is chosen such that after inserting the fastening mechanism in the opening, the carrier element is urged against the inside door piece.

9. The assembly unit according to claim 1, wherein the carrier element is a door module and the inside door piece is an inside door steel sheet.

10. The assembly unit according to claim 1, wherein the carrier element is a window lifter rail and the inside door piece is a door module.

11. The assembly unit according to claim 1, wherein the carrier element is a window lifter rail and the inside door piece is an inside door steel sheet.
